(19) United States
(12) Patent Application Publication
(10) Pub. No.: US 2020/0072109 A1
(43) Pub. Date: Mar. 5, 2020

(54) AN EXHAUST GAS TREATMENT SYSTEM

(71) Applicant: VOLVO TRUCK CORPORATION, Göteborg (SE)

(72) Inventors: Fredrik Blomgren, Göteborg (SE); Soran Shwan, Mölndal (SE); Mathias Magnussson, Göteborg (SE)

(21) Appl. No.: 16/466,473

(22) PCT Filed: Dec. 16, 2016
(86) PCT No.: PCT/EP2016/081502

§ 371 Date: Jun. 4, 2019

(51) Int. Cl. F01N 3/20; F01N 13/00; F01N 3/10; B01D 53/94; B01J 29/072; B01J 23/22; B01J 23/04

(52) U.S. Cl. CPC F01N 3/2066; B01D 2255/2092; F01N 3/108; B01D 53/9418; B01D 53/9431; F01N 3/106; B01J 29/072; B01J 23/22; B01J 23/04; F01N 2610/02; B01D 2255/20723; B01D 2255/20761; B01D 2255/20738; B01D 2255/50; B01D 2255/2042; B01D 2255/2065; F01N 13/009

(57) ABSTRACT

The invention provides an exhaust gas treatment system (8) arranged to receive exhaust gases from an internal combustion engine (6), the system comprising an exhaust conduit (10) and a selective catalytic reduction (SCR) catalyst (12) provided in the exhaust conduit (10), characterized in that the system comprises a nitrogen dioxide reducing unit (701) provided in the exhaust conduit (10) upstream of the SCR catalyst (12), wherein the nitrogen dioxide reducing unit (701) is adapted to reduce, at a low temperature, nitrogen dioxide (NO2) in exhaust gases received by the nitrogen dioxide reducing unit (701).

### TECHNICAL FIELD

The invention relates to an exhaust gas treatment system arranged to receive exhaust gases from an internal combustion engine, for example of a motor vehicle, the system comprising an exhaust conduit, and a selective catalytic reduction catalyst provided in the exhaust conduit.

The invention can be applied in heavy-duty vehicles, such as trucks, buses, and construction equipment, such as wheel loaders, haulers and excavators. Although the invention will be described with respect to a truck, the invention is not restricted to this particular vehicle, or any other type of heavy-duty vehicle, but may also be used in other vehicles such as passenger cars. The invention may also be used on other transportation means such as trains, ships and boats.

### BACKGROUND

As further requirements are introduced of limits of emissions from internal combustion engines adapted for a diesel cycle, the need for new technical solutions occurs. One problem that needs to be addressed is the reduction of nitrogen oxides (NOx) emissions during relatively cold operations, e.g. during cold start operations.

Devices for reducing NOx contained in exhaust gases discharged from an internal combustion engine, e.g. adapted for a diesel cycle, may include a selective catalytic reduction (SCR) catalyst in the exhaust system of the engine. Thereby, a reducing agent such as urea is supplied to the exhaust gases for generating ammonia to be adsorbed on the SCR catalyst, thereby selectively reducing NOx contained in the exhaust gas.

However, the performance of an SCR catalyst is limited at low temperatures, whereby the NOx reduction will not be effective. US2016032803A1 suggests providing an aftertreatment system comprising a low temperature SCR catalyst having a mixture of certain catalytic metals provided on a beta-zeolite support material. However, there is still a desire to avoid situations where the capacity of an SCR catalyst is reduced whereby the level of NOx in the exhaust gases is not reduced as desired.

### SUMMARY

An object of the invention is to reduce emissions from internal combustion engines. Another object of the invention is to improve an internal combustion engine exhaust gas treatment at low temperatures.

The objects are achieved by an exhaust gas treatment system according to claim 1. Thus the invention provides an exhaust gas treatment system arranged to receive exhaust gases from an internal combustion engine, the system comprising an exhaust conduit and a selective catalytic reduction (SCR) catalyst provided in the exhaust conduit, wherein the system further comprises a nitrogen dioxide reducing unit provided in the exhaust conduit upstream of the SCR catalyst, wherein the nitrogen dioxide reducing unit is adapted to reduce, at a low temperature, nitrogen dioxide (NO2) in exhaust gases received by the nitrogen dioxide reducing unit.

The internal combustion engine may be a diesel engine. The exhaust conduit is herein also referred to as an exhaust passage. The exhaust conduit may be exemplified with a tube, channel or other structure with one or more walls defining a space for an exhaust flow. It is understood that the selective catalytic reduction catalyst may provide nitrogen oxides (NOx) reduction.

The nitrogen dioxide reducing unit is preferably adapted to reduce, at a low temperature of the nitrogen dioxide reducing unit, nitrogen dioxide in exhaust gases received by the nitrogen dioxide reducing unit. The nitrogen dioxide reducing unit may be adapted to reduce, at a low temperature of the SCR unit, nitrogen dioxide in exhaust gases received by the nitrogen dioxide reducing unit. Thereby, where the exhaust gases are warmer than the nitrogen dioxide reducing unit and the SCR unit, e.g. at a cold start event of the engine, the nitrogen dioxide reducing unit is adapted to, when exposed to exhaust gases with a low temperature, reduce nitrogen dioxide in exhaust gases received by the nitrogen dioxide reducing unit.

The invention is based on the fact that when the temperature of the SCR catalyst is low, in the SCR catalyst there may be a build-up of deposits of ammonium nitrate (NH4NO3), produced by the reaction of NO2 and ammonia (NH3) provided from thermolysis of urea (CO(NH2)2) injected to provide a reductant for the SCR catalyst. If the amount of produced ammonium nitrate is large, it may take a lot of time until the ammonium nitrate is removed, even when the temperature of the SCR catalyst is increased. Thus, the SCR catalyst becomes poisoned by the ammonium nitrate, and thereby the efficiency of the SCR catalyst is reduced whereby the level of NOx in the exhaust gases is not reduced as desired. Said reaction to form ammonium nitrate may take place at temperatures below about 200° C. Such blocking ammonium nitrate may be released above 200° C., but the SCR catalyst may not regain its full capacity until all ammonium nitrate has been released.

Providing the nitrogen dioxide reducing unit being adapted to reduce, at a low temperature, NO2 in exhaust gases received by the nitrogen dioxide reducing unit, one of the ingredients for said reaction producing ammonium nitrate will be removed, and thereby ammonium nitrate production, and the risk of SCR catalyst poisoning, may be avoided. Thus, ammonia may be provided as a reductant for the NOx reducing process of the SCR catalyst, even if the SCR catalyst temperature is low. Hence the NOx conversion process of the SCR catalyst is facilitated also at low temperatures. Thus emissions from the engine are reduced.

Preferably, the nitrogen dioxide reducing unit is adapted to reduce nitrogen dioxide in the exhaust gases at a cold start event of the engine. I.e. since a low temperature of the SCR catalyst will be provided at an engine cold start event, the nitrogen dioxide reducing unit will be advantageously adapted to reduce NO2 in the exhaust gases during the cold start. Thereby, ammonia may be provided as a reductant for the NOx reducing process of the SCR catalyst at a cold start event of the engine.

Preferably, the nitrogen dioxide reducing unit is adapted to not reduce nitrogen dioxide in the exhaust gases when exposed to at a high temperature. When the exhaust gas treatment system is, after a cold start event, warmed up to a normal operating temperature, or when the engine is operating under a high load, the SCR catalyst may present a high temperature. Thereby, the temperature may be too high for the formation of ammonium nitrate from ammonia and NO2, and the risk of SCR catalyst poisoning is eliminated. This means that NO2 may be included in the normal SCR process for production of nitrogen gas (N2).

Preferably, the system comprises means for supplying ammonia to the exhaust gases when the temperature of exhaust gases, e.g. as received by the nitrogen dioxide reducing unit, are low. Preferably, the system comprises means for supplying ammonia, e.g. into the exhaust conduit, to the exhaust gases, upstream of the SCR catalyst, at exhaust gas temperatures, e.g. at the nitrogen dioxide reducing unit, below 200° C. By supplying ammonia, rather than urea as a precursor for ammonia through thermolysis, to the exhaust gases, the ammonia may be readily available for the NOx reducing process of the SCR catalyst even at a low exhaust gas temperature.

More specifically, in the case of urea being used as precursor for ammonia which is used as a reductant for the SCR process, ammonia will not be formed at temperatures below 160-180 degrees Celsius. Embodiments of the invention provides instead for supplying ammonia to the exhaust gases e.g. by an ammonia source or an ammonia generator, arranged to inject ammonia into the exhaust stream. Thereby, the ammonia may be provided to the SCR catalyst, and the NOx reducing process of the SCR catalyst may be provided at low temperatures, e.g. at engine cold starts. Thus, means for supplying ammonia is advantageously provided as an alternative to means for injecting urea into the exhaust conduit. In the latter case, ammonia will not be formed at temperatures below 160-180 degrees. However, the means for supplying ammonia to the exhaust gases may secure the provision of ammonia to the SCR catalyst at low exhaust gas temperatures.

Thus, the means for supplying ammonia may provide ammonia at low exhaust gas temperatures, while the nitrogen dioxide reducing unit may reduce or eliminate the nitrogen dioxide reaching the SCR catalyst, whereby ammonium nitrate production from the nitrogen dioxide and the ammonium, and thus SCR catalyst ammonium nitrate poisoning may be avoided, thereby effectively securing the NOx reducing process of the SCR catalyst also at low exhaust temperatures.

The means for supplying ammonia may in some embodiments comprise means to inject a precursor into the exhaust conduit, and an ammonia production catalyst adapted to produce ammonia from the injected precursor at exhaust gas temperatures below 200° C. Thereby the exhaust conduit may comprise a main conduit and a bypass conduit, the bypass conduit being branched from the main conduit and arranged to reintroduce exhaust gases into main conduit upstream of the SCR catalyst, the ammonia production catalyst being located in the bypass conduit.

Thus, the system may present an additional conduit extending between two separate locations of the exhaust conduit, and the ammonia source may comprise a catalytic converter arranged in the additional conduit, the catalytic converter being arranged to produce ammonia from exhaust gases from the engine. Thereby, the supply of ammonia for the SCR catalyst process at low exhaust temperatures may be secured.

In some embodiments, the means for supplying ammonia may comprise means for receiving ammonia in solid form. Thereby a further effective way of providing ammonia for the SCR catalyst at low exhaust gas temperatures may be provided.

It should be noted that the system may also comprise means for supplying urea to the exhaust gases when the exhaust gases are of high temperature for evaporation or thermolysis, and forming of ammonia, that the urea supplying means being provided in the exhaust conduit upstream of the SCR catalyst.

In particularly advantageous embodiments, the nitrogen dioxide reducing unit is arranged to reduce nitrogen dioxide in the exhaust gases by deposition in the nitrogen dioxide reducing unit of ammonium nitrate provided by a reaction of the nitrogen dioxide in the exhaust gases with ammonia in the exhaust gases to produce the ammonium nitrate. Preferably, where the system comprises means for supplying ammonia upstream of the nitrogen dioxide reducing unit, the nitrogen dioxide reducing unit and the SCR catalyst are adapted, preferably through their respective compositions, so that in the nitrogen dioxide reducing unit ammonium nitrate is formed from ammonia and nitrogen dioxide faster than ammonium nitrate is formed from ammonia and nitrogen dioxide in the SCR catalyst. The nitrogen dioxide reducing unit may be arranged to store the ammonium nitrate formed in the nitrogen dioxide reducing unit.

Thereby, the nitrogen dioxide reducing unit may serve as a sacrifice unit, which stores ammonium nitrate, the production of which consumes all of, or at least a major portion of the nitrogen dioxide in the exhaust gases. Thereby, the nitrogen dioxide reaching the SCR catalyst, and ammonium nitrate being formed therein, may be avoided. Thus, at low SCR catalyst temperatures, e.g. at cold start, this will provide for only ammonia and nitric oxide (NO) reaching the SCR catalyst, where the NO is reduced to N2 by the ammonia. This will drastically lower the NOx emission at low SCR catalyst temperatures.

Preferably, the nitrogen dioxide reducing unit presents a length and/or a site density so as for the nitrogen dioxide reducing unit to form the ammonium nitrate from the ammonia and substantially all nitrogen dioxide reaching the nitrogen dioxide reducing unit, and to store substantially all the formed ammonium nitrate. Thereby, the nitrogen dioxide reducing unit may store the ammonium nitrate, the production of which consumes substantially all of the nitrogen dioxide in the exhaust gases. The nitrogen dioxide reducing unit is preferably large enough to be able to provide a reaction of substantially all of the incoming NO2, e.g. during a SCR catalyst heat up process.

Preferably, the nitrogen dioxide reducing unit and the SCR catalyst are arranged, e.g. matched, so that the ammonium nitrate stored in the nitrogen dioxide reducing unit is not released from the nitrogen dioxide reducing unit below a temperature in the SCR catalyst at which at least one product formed by a decomposition of the ammonium nitrate stored in the nitrogen dioxide reducing unit is converted in the SCR catalyst. The ammonium nitrate stored in the nitrogen dioxide reducing unit may be released from the nitrogen dioxide reducing unit by such a decomposition of the ammonium nitrate. The at least one product formed by the decomposition may be nitrous oxide (N2O), also known as laughing gas. In some embodiments, the at least one product formed by the decomposition may be nitrogen dioxide (NO2) and ammonia (NH3). In some embodiments, N2O, NO2 and NH3 may all be formed at a decomposition of the ammonium nitrate stored in the nitrogen dioxide reducing unit. Thus, it may be secured that the SCR catalyst is not exposed to such decomposition products unless it has reached a temperature at which the decomposing products are converted in the SCR catalyst.

Preferably, the nitrogen dioxide reducing unit is arranged so that the ammonium nitrate stored in the nitrogen dioxide reducing unit is not released from the nitrogen dioxide reducing unit at temperatures below 200° C. Preferably, the nitrogen dioxide reducing unit is arranged so that the ammonium nitrate stored in the nitrogen dioxide reducing unit is not released from the nitrogen dioxide reducing unit at temperatures of the nitrogen dioxide reducing unit below 200° C. Preferably, the nitrogen dioxide reducing unit is arranged so that the ammonium nitrate stored in the nitrogen dioxide reducing unit is not released from the SCR catalyst at temperatures of the nitrogen dioxide reducing unit below 200° C. Thereby, it may be secured that the SCR catalyst is not exposed to ammonium nitrate at low temperatures. As suggested, at temperatures below about 200° C., ammonia can react with nitrogen dioxide (NO2) in the exhaust stream, to form the ammonium nitrate which may poison the SCR catalyst by blocking the active catalytic surfaces of the SCR catalyst. Since the nitrogen dioxide reducing unit is able to consume the nitrate dioxide and store the ammonium nitrate, and to not release it at temperatures below 200° C., such poisoning may be avoided.

Preferably, the SCR catalyst is a second SCR catalyst, and the nitrogen dioxide reducing unit is a first SCR catalyst. The first catalyst may be provided downstream of the means for supplying ammonia and upstream of the second SCR catalyst. The first SCR catalyst may thereby be arranged to become poisoned by ammonium nitrate to thereby absorb at least a major part of the nitrogen dioxide in the exhaust gases. Thereby a simple and cost effective solution is provided.

Preferably, the nitrogen dioxide reducing unit and the SCR catalyst form an integrated element. For example, the nitrogen dioxide reducing unit may be formed by zone coating of the integrated element. Thereby first and second zones may be formed. The purpose of the first zone is the convert and store NO2 until the temperature of the SCR catalyst is sufficiently high so that the formation of ammonium nitrate does not occur over the active SCR coating. As suggested, at low temperatures, e.g. at cold start, this will provide for only ammonia and NO reaching the second zone, where the NO is reduced to N2 by the ammonia. This will drastically lower the NOx emission at low temperatures.

In some embodiments, the nitrogen dioxide reducing unit and the SCR catalyst are formed by two separate bricks. These separate bricks may be provided at a distance from each other. Thereby, a further advantageous alternative for avoiding ammonium nitrate poisoning of the SCR catalyst is provided.

Preferably, the nitrogen dioxide reducing unit and the SCR catalyst present different active catalytic materials. The nitrogen dioxide reducing unit may comprise e.g. a copper (Cu) zeolite and/or an iron (Fe) zeolite. The SCR catalyst may comprise e.g. an oxide of vanadium. Thereby it will be secured that the sacrifice SCR will have a material that is poisoned faster and harder than the regular SCR material. Thus, it may be secured that the nitrate dioxide reducing unit provides the sacrifice function described above.

Preferably, the nitrogen dioxide reducing unit is adapted to reduce nitrogen dioxide in the exhaust gases at temperatures below 200° C. Preferably, the nitrogen dioxide reducing unit is adapted to reduce nitrogen dioxide in the exhaust gases at temperatures of the nitrogen dioxide reducing unit below 200° C. Preferably, the nitrogen dioxide reducing unit is adapted to reduce nitrogen dioxide in the exhaust gases at temperatures of the SCR catalyst below 200° C. Since, as suggested above, at temperatures below about 200° C., ammonia can react with nitrogen dioxide (NO2) in the exhaust stream, to form ammonium nitrate which may poison the SCR catalyst by blocking the active catalytic surfaces of the SCR catalyst, the nitrogen dioxide reducing unit being adapted to reduce NO2 in the exhaust gases at temperatures below 200° C. will secure that ammonium nitrate formation and SCR catalyst poisoning is avoided.

Preferably, the nitrogen dioxide reducing unit is adapted to not reduce nitrogen dioxide in the exhaust gases at temperatures above 200° C. Preferably, the nitrogen dioxide reducing unit is adapted to not reduce nitrogen dioxide in the exhaust gases at temperatures of the nitrogen dioxide reducing unit above 200° C. Preferably, the nitrogen dioxide reducing unit is adapted to not reduce nitrogen dioxide in the exhaust gases at temperatures of the SCR catalyst above 200° C. As suggested above, the reaction to form ammonium nitrate may be absent at temperatures above about 200° C. Hence, since at such temperatures, the nitrogen dioxide reducing unit is adapted to not reduce NO2 in the exhaust gases, NO2 may be converted to N2 in the normal SCR catalyst process.

Embodiments of the invention may advantageously involve the nitrogen dioxide reducing unit being adapted to reduce nitrogen dioxide in the exhaust gases by storing nitrogen dioxide in the exhaust gases. Thus, the nitrogen dioxide reducing unit may be adapted to, when exposed to exhaust gases at a low temperature, to reduce NO2 in exhaust gases received by the nitrogen dioxide reducing unit, by storing the NO2 . Such a function may be provided as an alternative, or in addition to the sacrificial function described above. The NO2 storage may secure that the SCR catalyst is not exposed to NO2 at low temperatures, whereby the risk of SCR catalyst ammonium nitrate poisoning may be reduced or eliminated.

Preferably, the nitrogen dioxide reducing unit is adapted to not store nitrogen dioxide in the exhaust gases at temperatures above 250° C. Preferably, the nitrogen dioxide reducing unit is adapted to not store nitrogen dioxide in the exhaust gases at temperatures of the nitrogen dioxide reducing unit above 250° C. Preferably, the nitrogen dioxide reducing unit is adapted to not store nitrogen dioxide in the exhaust gases at temperatures of the SCR catalyst above 250° C. An SCR catalyst may provide a substantially complete conversion of NOx, including NO2, above 250° C. Therefore, the nitrogen dioxide reducing unit is adapted to not store nitrogen dioxide in the exhaust gases at temperatures above this temperature, the NO2 may be converted to N2 in the SCR catalyst process.

Preferably, the nitrogen dioxide reducing unit is adapted to reduce the nitrogen dioxide by adsorption of the nitrogen dioxide. Thereby, exposure of NO2 to the SCR catalyst may be efficiently avoided at low temperatures.

Preferably, the nitrogen dioxide reducing unit is adapted to release adsorbed nitrogen dioxide at temperatures above 200° C. Preferably, the nitrogen dioxide reducing unit is adapted to release adsorbed nitrogen dioxide at temperatures of the nitrogen dioxide reducing unit above 200° C. Preferably, the nitrogen dioxide reducing unit is adapted to release adsorbed nitrogen dioxide at temperatures of the SCR catalyst above 200° C. Thereby, the nitrogen dioxide reducing unit may be adapted to release the stored NO2 at high temperatures. Also, the nitrogen dioxide reducing unit may be adapted to not reduce nitrogen dioxide in the exhaust gases at a high temperature, e.g. of the nitrogen dioxide reducing unit, or of the SCR catalyst.

In some embodiments the nitrogen dioxide reducing unit may be adapted to reduce the nitrogen dioxide by converting the nitrogen dioxide to nitrogen oxide (NO). For example, at low temperatures a major portion, or substantially all of the incoming NO2 may be adsorbed. One portion of the adsorbed NO2 may immediately or at least with a short time frame be converted to NO and released. Another portion of the adsorbed NO2 may be stored and released at a higher temperature, e.g. at 200° C. or above. Thereby, a selective NO2 adsorber may be provided, which changes its function in dependence on the temperature. Thus, a particularly advantageous solution is provided, which effectively ensures that the SCR catalyst is not exposed to NO2 at low temperatures.

The nitrogen dioxide reducing unit may comprise barium oxide, cerium oxide, and/or aluminum oxide. Thereby, the nitrogen dioxide reducing unit may be particularly adapted for storage of NO2 at low temperatures.

Preferably, the system comprises means for supplying ammonia to the exhaust gases, upstream of the SCR catalyst and downstream of the nitrogen dioxide reducing unit. Thereby, the ammonia may be injected between the nitrogen dioxide reducing unit and the SCR catalyst. Thereby, the risk of formation of ammonium nitrate in the nitrogen dioxide reducing unit is avoided. Instead, the nitrogen dioxide reducing unit may store store or convert only pure NO2. By avoiding formation of ammonium nitrate, a potential formation of nitric oxide N2O from a decomposition of ammonium nitrate will be avoided. However, in some embodiments, where the nitrogen dioxide reducing unit is adapted to store NO2 and/or convert NO2 to NO, the means for supplying ammonia may be arranged to supply the ammonia upstream of the nitrogen dioxide reducing unit.

In advantageous embodiments, the nitrogen dioxide reducing unit comprises an alkaline metal or an alkaline earth metal. Thereby, the nitrogen dioxide reducing unit will be well adapted to store NO2. In particularly preferred embodiments, the nitrogen dioxide reducing unit comprises potassium (K), barium (Ba), strontium (Sr), sodium (Na), calcium (Ca), lithium (Li) and/or magnesium (Mg).

In some embodiments, the system comprises in addition to the nitrogen dioxide reducing unit an oxidation catalyst provided in the exhaust conduit, preferably upstream of the SCR catalyst, and preferably upstream of the nitrate dioxide reducing unit. In further embodiments, the oxidation catalyst may be provided downstream of the nitrate dioxide reducing unit, and in some embodiments even downstream of the SCR catalyst. The oxidation catalyst may be a diesel oxidation catalyst (DOC). Thereby, the system will be provided with means to oxidize hydrocarbons and carbon monoxide to form carbon dioxide and water.

The objects are also reached with a vehicle comprising an exhaust gas treatment system according to any one of the appended exhaust gas treatment system claims and any one of the embodiments described herein.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1 is a side view of a truck comprising an internal combustion engine with an exhaust gas treatment system.

FIG. 2 shows an embodiment of an internal combustion engine system comprising an internal combustion engine and an exhaust gas treatment system.

FIG. 3 and FIG. 4 show further embodiments of internal combustion engine systems.

FIG. 5 shows two graphs depicting the result of a process in a nitrogen dioxide reducing unit in the internal combustion engine system in FIG. 4.

FIG. 6 shows yet another embodiment of an internal combustion engine system.

### DETAILED DESCRIPTION OF EXAMPLE EMBODIMENTS OF THE INVENTION

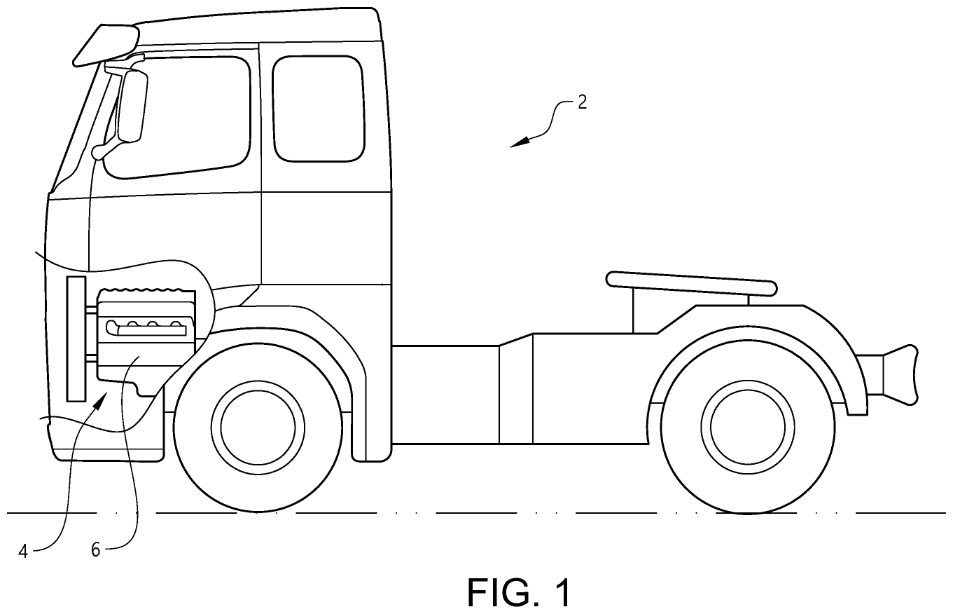

FIG. 1 shows a vehicle 2 in the form of a truck in a partly cut side view. The vehicle 2 has an internal combustion engine system 4 for the propulsion of the vehicle 2. The internal combustion engine system 4 comprises an internal combustion engine 6 in the form of a diesel engine.

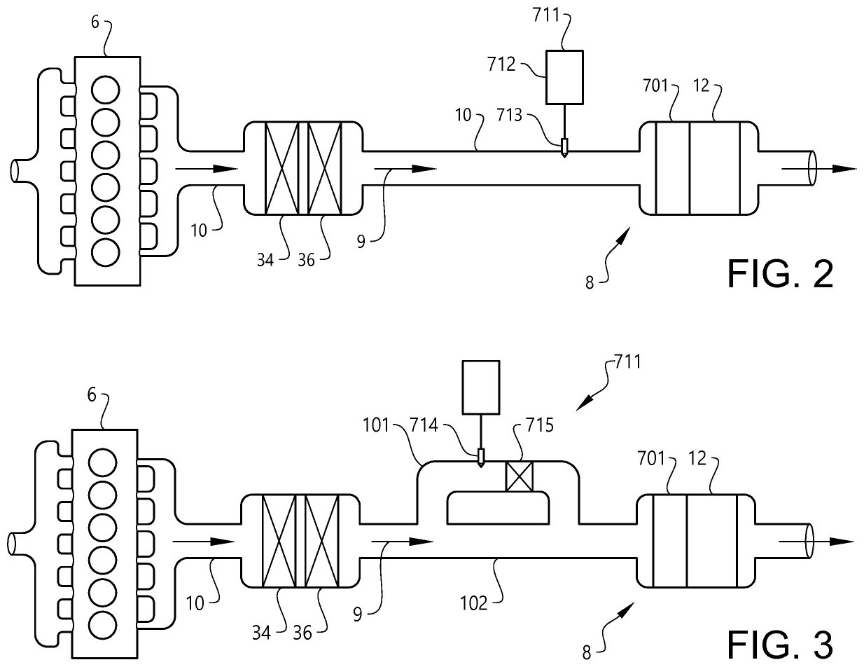

FIG. 2 shows a first embodiment of an internal combustion engine system comprising the internal combustion engine 6 and an exhaust gas treatment system 8 for treating exhaust gases from the engine 6. The exhaust gas treatment system 8 comprises an exhaust passage 10, or herein also referred to as an exhaust conduit 10 or an exhaust gas line, in the form of a tube for conveying exhaust gases, see arrow 9, discharged from the engine 6.

The exhaust gas treatment system 8 further comprises a selective catalytic reduction (SCR) catalyst 12 provided in the exhaust passage 10 for selectively reducing NOx contained in the exhaust gas. The SCR catalyst 12 forms a body with an external shape and size matched to an internal shape and size of the exhaust passage so that no, or at least very small amount of, exhaust gases may pass the SCR catalyst 12 without being treated. The SCR catalyst 12 may be formed by a brick of a porous construction. The porosity is what gives the catalyst the high surface area essential for reduction of NOx. Further, the selective catalytic reduction catalyst may be coated on a flow-through monolith.

The exhaust gas treatment system 8 further comprises ammonia supply means 711, or means 711 for supplying ammonia into the exhaust passage 10 upstream of the SCR catalyst 12, for the NOx reduction process in the SCR catalyst. The ammonia supply means 711 comprises means 712 for receiving ammonia in solid form. For example, the ammonia may be provided as a product marketed under the name of AdAmmine™ by the company Amminex Emissions Technology A/S. The ammonia supply means 711 is arranged to convert the solid ammonia to liquid ammonia. The ammonia supply means 711 is further arranged to spray by means of an injector 713 the ammonia into the exhaust gas passage 10.

Thus, the system does not provide for injecting urea into the exhaust passage 10 for the SCR catalyst process, since this requires thermolysis of the urea, which in turn requires a relatively high exhaust gas temperature. Supplying ammonia to the exhaust gases allows supplying a reductant for the SCR catalyst process also when the temperature of exhaust gases are low, e.g. below 200° C.

The exhaust gas treatment system 8 further comprises upstream of the SCR catalyst 12 and upstream of the injector 713 an oxidation catalyst (DOC) 34 having the function of oxidizing carbon monoxide (CO), hydrocarbons (HC) and nitrogen monoxide (NO) contained in the exhaust gases. The DOC 34 may use precious metals such as platinum and/or palladium.

The exhaust gas treatment system 8 further comprises a diesel particulate filter (DPF) 36 disposed downstream of the DOC 34 and upstream of the injector 713 for capturing and collecting particulate matter contained in exhaust gas. The DPF may also have catalytic functions for oxidizing.

The exhaust gas treatment system 8 also comprises a nitrogen dioxide reducing unit 701 provided in the exhaust conduit 10 upstream of the SCR catalyst 12 and downstream of the injector 713. The nitrogen dioxide reducing unit 701 forms a body with an external shape and size matched to an internal shape and size of the exhaust passage 10 so that no, or at least very small amount of, exhaust gases may pass the nitrogen dioxide reducing unit 701 without being manipulated as described below.

The nitrogen dioxide reducing unit 701 is adapted to reduce nitrogen dioxide (NO2) in exhaust gases received by the nitrogen dioxide reducing unit 701 at a low temperature, more specifically below 200° C., e.g. at a cold start event of the engine 6 or at a low load operation of the engine.

The nitrogen dioxide reducing unit 701 is arranged to reduce NO2 in the exhaust gases by deposition in the nitrogen dioxide reducing unit 701 of ammonium nitrate (NH4NO3) provided by a reaction of the NO2 in the exhaust gases with ammonia injected by the ammonia supply means 711. Further, the nitrogen dioxide reducing unit 701 and the SCR catalyst 12 are adapted so that in the nitrogen dioxide reducing unit 701 ammonium nitrate is formed from ammonia and NO2 faster than ammonium nitrate is formed from ammonia and NO2 in the SCR catalyst 12.

The nitrogen dioxide reducing unit 701 presents a length and a site density so as for the nitrogen dioxide reducing unit 701 to form the ammonium nitrate from the ammonia and substantially all NO2 reaching the nitrogen dioxide reducing unit 701, and to store substantially all the formed ammonium nitrate.

Thereby, the nitrogen dioxide reducing unit 701 provides a sacrifice function whereby nitrogen dioxide reducing unit 701 during low temperature operations gets “poisoned” by ammonium nitrate and the SCR catalyst 12 is avoids such poisoning due to the fact that the NO2 in the exhaust gases have been consumed by the ammonium nitrate forming process in the nitrogen dioxide reducing unit 701. Enough ammonia is injected by the ammonia supply means 711 to support the NOx reduction process of the SCR catalyst 12 as well as the ammonium nitrate forming process in the nitrogen dioxide reducing unit 701.

The nitrogen dioxide reducing unit 701 and the SCR catalyst 12 are arranged so that the ammonium nitrate stored in the nitrogen dioxide reducing unit 701 is not released from the nitrogen dioxide reducing unit 701 below a temperature in the SCR catalyst 12, e.g. 200° C., at which products, exemplified above as N2O, NO2 and NH3, formed by a decomposition of the ammonium nitrate stored in the nitrogen dioxide reducing unit is converted in the SCR catalyst 12. Further, the nitrogen dioxide reducing unit 701 is adapted to not reduce nitrogen dioxide in the exhaust gases at temperatures above 200° C.

The nitrogen dioxide reducing unit 701 may be an SCR catalyst, herein referred to as a first SCR catalyst 12, and the SCR catalyst described above may be referred to as a second SCR catalyst 12. In this embodiment, the nitrogen dioxide reducing unit 701 and the SCR catalyst 12 form an integrated element. Thereby, the nitrogen dioxide reducing unit 701 may be formed by zone coating of the integrated element. In alternative embodiments, the nitrogen dioxide reducing unit 701 and the SCR catalyst 12 may be formed by two separate bricks.

The nitrogen dioxide reducing unit 701 and the SCR catalyst 12 present different active catalytic materials, whereby said sacrificial function of the nitrogen dioxide reducing unit 701 is provided. The nitrogen dioxide reducing unit 701 may comprise a copper (Cu) zeolite and/or an iron (Fe) zeolite, and the SCR catalyst 12 may comprise an oxide of vanadium. More generally, the SCR catalyst 12 may be made from a ceramic materials used as a carrier, such as titanium oxide, and active catalytic components being oxides of base metals, such as vanadium, molybdenum and tungsten, zeolites, or various precious metals.

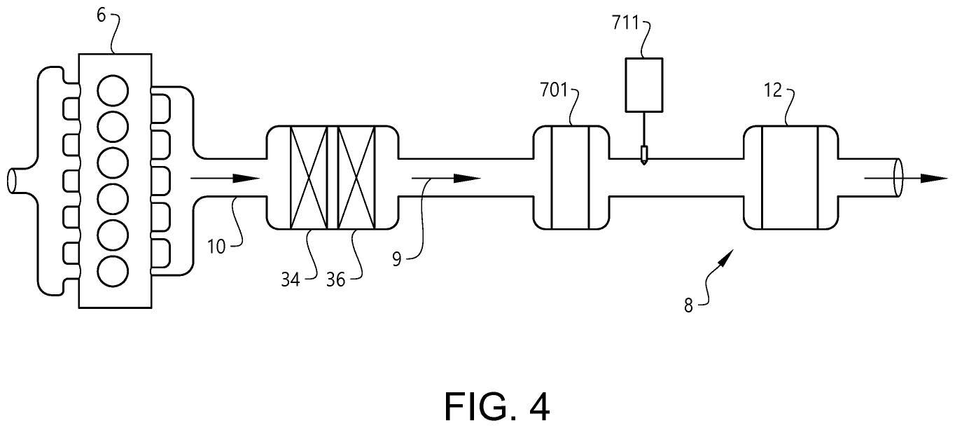

Reference is made to FIG. 3 showing an alternative embodiment of the invention. Herein the exhaust conduit 10 comprises a main conduit 102 and a bypass conduit 101, the bypass conduit 101 being branched from the main conduit 102 and arranged to reintroduce exhaust gases into main conduit upstream of the SCR catalyst 12. The means 711 for supplying ammonia comprises an ammonia production catalyst 715 located in the bypass conduit 101, and means 714 to inject a precursor into the bypass conduit 101, upstream of the ammonia production catalyst 715. The ammonia production catalyst 715 is adapted to produce ammonia from the injected precursor at exhaust gas temperatures below 200° C. The ammonia production catalyst is preferably relatively small in size. In some embodiments, the ammonia production catalyst comprises titanium dioxide (TiO2). The precursor may be urea or of any other type of ammonia carrier, e.g. ammonia carbamate, isocyanate, and guanidinium formate or similar.

Reference is made to FIG. 4 showing yet another embodiment of the invention. Herein the means 711 for supplying ammonia to the exhaust gases is arranged to supply the ammonia downstream of the nitrogen dioxide reducing unit 701. The nitrogen dioxide reducing unit 701 is adapted to reduce nitrogen dioxide in the exhaust gases, at low temperatures, by storing nitrogen dioxide in the exhaust gases, and by converting the nitrogen dioxide to nitrogen oxide (NO). For this the nitrogen dioxide reducing unit 701 may comprise an alkaline metal or an alkaline earth metal. In some embodiments the nitrogen dioxide reducing unit 701 comprises barium oxide, cerium oxide, and/or aluminum oxide.

The nitrogen dioxide reduction process of the nitrogen dioxide reducing unit 701 comprises adsorption of the nitrogen dioxide. Thereby, one portion of the adsorbed NO2 is immediately converted to NO and released. Another portion of the adsorbed NO2 is stored and released at a higher temperature, e.g. at 200° C. or above. Further, the nitrogen dioxide reducing unit 701 is adapted to not store nitrogen dioxide in the exhaust gases at temperatures above 250° C.

It should be noted that the arrangement shown in FIG. 4, where the means 711 for supplying ammonia to the exhaust gases is arranged to supply the ammonia downstream of the nitrogen dioxide reducing unit 701, may be provided, as in FIG. 3, with an ammonia production catalyst 715 located in a bypass conduit 101, and means 714 to inject a precursor into the bypass conduit 101, upstream of the ammonia production catalyst 715.

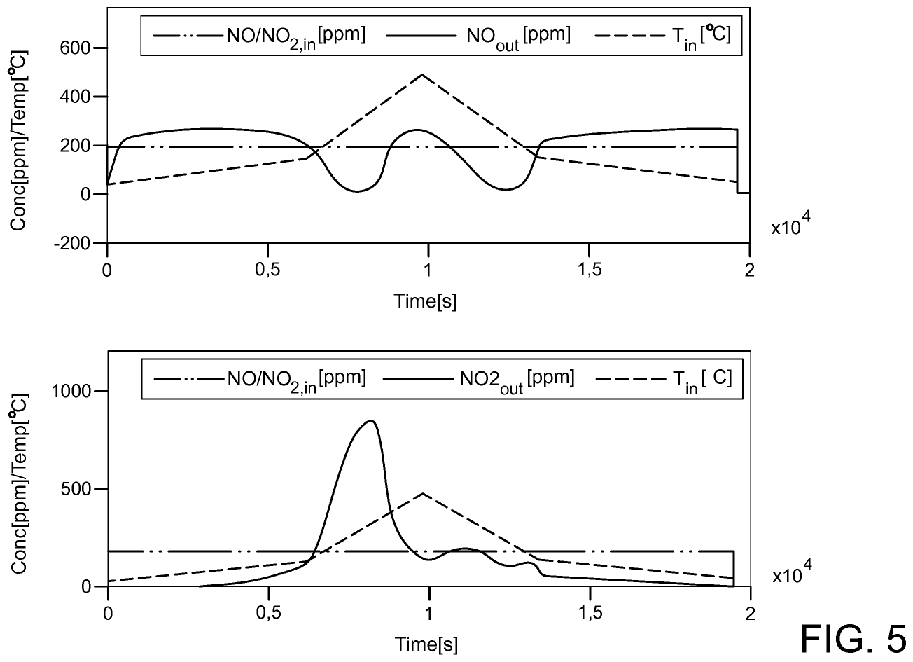

The graphs of FIG. 5 show the result of a test conducted by the inventors, with a nitrogen dioxide reducing unit according to an embodiment of the invention. The graphs show the variation of the amounts of NO2 and NO coming out of the nitrogen dioxide reducing unit 701 as the temperature changes. As can be seen the total amount of NO2 and NO coming into the nitrogen dioxide reducing unit is constant. In the upper graph it can be seen that at low temperatures the amount of NO is relatively high, but as the temperature increases the amount of NO is reduced. In the lower graph it can be seen that at low temperatures the amount of NO2 is relatively low, but as the temperature increases the amount of NO2 is increased.

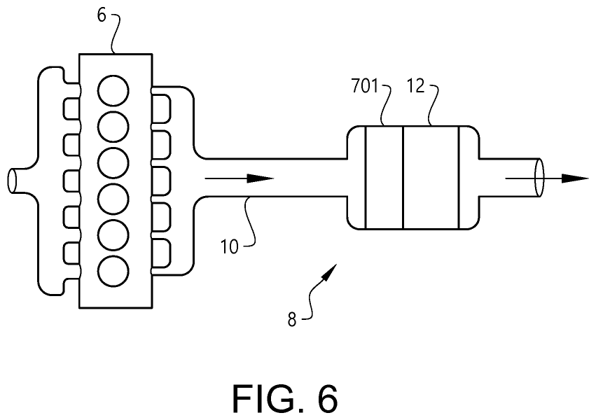

FIG. 6 shows a further embodiment of the invention. The exhaust gas treatment system 8 comprises an exhaust conduit 10 and an SCR catalyst 12 provided in the exhaust conduit 10. The system further comprises a nitrogen dioxide reducing unit 701 provided in the exhaust conduit 10 upstream of the SCR catalyst 12. The nitrogen dioxide reducing unit 701 is adapted to reduce, at a low temperature, nitrogen dioxide NO2 in exhaust gases received by the nitrogen dioxide reducing unit 701. Advantages thereof have been discussed above.

It is to be understood that the present invention is not limited to the embodiments described above and illustrated in the drawings; rather, the skilled person will recognize that many changes and modifications may be made within the scope of the appended claims.

1. An exhaust gas treatment system (8) arranged to receive exhaust gases from an internal combustion engine (6), the system comprising an exhaust conduit (10) and a selective catalytic reduction (SCR) catalyst (12) provided in the exhaust conduit (10), characterized in that the system comprises a nitrogen dioxide reducing unit (701) provided in the exhaust conduit (10) upstream of the SCR catalyst (12), wherein the nitrogen dioxide reducing unit (701) is adapted to reduce, at a low temperature, nitrogen dioxide (NO2) in exhaust gases received by the nitrogen dioxide reducing unit (701).

2. A system according to claim 1, characterized in that the nitrogen dioxide reducing unit (701) is adapted to reduce nitrogen dioxide in the exhaust gases at a cold start event of the engine (6).

3. A system according to claim 1, characterized in that the nitrogen dioxide reducing unit (701) is adapted to not reduce nitrogen dioxide in the exhaust gases at a high temperature.

4. A system according to claim 1, characterized in that the system comprises means (711) for supplying ammonia (NH3) to the exhaust gases when the temperature of exhaust gases are low.

5. A system according to claim 1, characterized in that the system comprises means (711) for supplying ammonia (NH3) to the exhaust gases, upstream of the SCR catalyst (12), at exhaust gas temperatures below 200° C.

6. A system according to claim 5, characterized in that the means (711) for supplying ammonia comprises means to inject a precursor into the exhaust conduit (10), and an ammonia production catalyst (715) adapted to produce ammonia from the injected precursor at exhaust gas temperatures below 200° C.

7. A system according to claim 6, characterized in that the exhaust conduit (10) comprises a main conduit (102) and a bypass conduit (101), the bypass conduit being branched from the main conduit and arranged to reintroduce exhaust gases into main conduit upstream of the SCR catalyst (12), the ammonia production catalyst (715) being located in the bypass conduit.

8. A system according to claim 5, characterized in that the means (711) for supplying ammonia comprises means for receiving ammonia in solid form.

9. A system according to claim 1, characterized in that the nitrogen dioxide reducing unit (701) is arranged to reduce nitrogen dioxide in the exhaust gases by deposition in the nitrogen dioxide reducing unit (701) of ammonium nitrate provided by a reaction of the nitrogen dioxide in the exhaust gases with ammonia in the exhaust gases to produce the ammonium nitrate.

10. A system according to claim 1, characterized in that the system further comprises means (711) for supplying ammonia upstream of the nitrogen dioxide reducing unit (701), the nitrogen dioxide reducing unit (701) and the SCR catalyst (12) being adapted so that in the nitrogen dioxide reducing unit (701) ammonium nitrate (NH4NO3) is formed from ammonia and nitrogen dioxide faster than ammonium nitrate is formed from ammonia and nitrogen dioxide in the SCR catalyst (12).

11. A system according to claim 10, characterized in that the nitrogen dioxide reducing unit (701) is arranged to store the ammonium nitrate formed in the nitrogen dioxide reducing unit (701).

12. A system according to claim 11, characterized in that the nitrogen dioxide reducing unit (701) presents a length and/or a site density so as for the nitrogen dioxide reducing unit (701) to form the ammonium nitrate from the ammonia and substantially all nitrogen dioxide reaching the nitrogen dioxide reducing unit (701), and to store substantially all the formed ammonium nitrate.

13. A system according to claim 11, characterized in that the nitrogen dioxide reducing unit (701) and the SCR catalyst (12) are arranged so that the ammonium nitrate stored in the nitrogen dioxide reducing unit (701) is not released from the nitrogen dioxide reducing unit (701) below a temperature in the SCR catalyst (12) at which at least one product formed by a decomposition of the ammonium nitrate stored in the nitrogen dioxide reducing unit is converted in the SCR catalyst (12).

14. A system according to claim 11, characterized in that the nitrogen dioxide reducing unit (701) is arranged so that the ammonium nitrate stored in the nitrogen dioxide reducing unit (701) is not released from the nitrogen dioxide reducing unit (701) at temperatures below 200° C.

15. A system according to claim 10, characterized in that the SCR catalyst (12) is a second SCR catalyst (12), and the nitrogen dioxide reducing unit (701) is a first SCR catalyst (12).

16. A system according to claim 1, characterized in that the nitrogen dioxide reducing unit (701) and the SCR catalyst (12) form an integrated element.

17. A system according to claim 16, characterized in that the nitrogen dioxide reducing unit (701) is formed by zone coating of the integrated element.

18. A system according to claim 1, characterized in that the nitrogen dioxide reducing unit (701) and the SCR catalyst (12) are formed by two separate bricks.

19. A system according to claim 1, characterized in that the nitrogen dioxide reducing unit (701) and the SCR catalyst (12) present different active catalytic materials.

20. A system according to claim 1, characterized in that the nitrogen dioxide reducing unit (701) comprises a copper (Cu) zeolite and/or an iron (Fe) zeolite.

21. A system according to claim 1, characterized in that the SCR catalyst (12) comprises an oxide of vanadium.

22. A system according to claim 1, characterized in that the nitrogen dioxide reducing unit (701) is adapted to reduce nitrogen dioxide in the exhaust gases at temperatures below 200° C.

23. A system according to claim 1, characterized in that the nitrogen dioxide reducing unit (701) is adapted to not reduce nitrogen dioxide in the exhaust gases at temperatures above 200° C.

24. A system according to claim 1, characterized in that the nitrogen dioxide reducing unit (701) is adapted to reduce nitrogen dioxide in the exhaust gases by storing nitrogen dioxide in the exhaust gases.

25. A system according to claim 24, characterized in that the nitrogen dioxide reducing unit (701) is adapted to not store nitrogen dioxide in the exhaust gases at temperatures above 250° C.

26. A system according to claim 1, characterized in that the nitrogen dioxide reducing unit (701) is adapted to reduce the nitrogen dioxide by adsorption of the nitrogen dioxide.

27. A system according to claim 26, characterized in that the nitrogen dioxide reducing unit (701) is adapted to release adsorbed nitrogen dioxide at temperatures above 200° C.

28. A system according to claim 1, characterized in that the nitrogen dioxide reducing unit (701) is adapted to reduce the nitrogen dioxide by converting the nitrogen dioxide to nitrogen oxide (NO).

29. A system according to claim 1, characterized in that the nitrogen dioxide reducing unit (701) comprises barium oxide, cerium oxide, and/or aluminum oxide.

30. A system according to claim 24, characterized in that the system comprises means (711) for supplying ammonia to the exhaust gases, upstream of the SCR catalyst (12) and downstream of the nitrogen dioxide reducing unit (701).

31. A system according to claim 24, characterized in that the nitrogen dioxide reducing unit (701) comprises an alkaline metal or an alkaline earth metal.

32. A system according to claim 1, characterized in that the system comprises in addition to the nitrogen dioxide reducing unit (701) an oxidation catalyst (34) provided in the exhaust conduit (10).

33. A vehicle comprising an exhaust gas treatment system according to claim 1.
